(19) United States
(12) Patent Application Publication
(10) Pub. No.: US 2017/0051384 A1
(43) Pub. Date: Feb. 23, 2017

(54) APPARATUS, MANUFACTURE, COMPOSITION AND METHOD FOR PRODUCING LONG LENGTH TUBING AND USES THEREOF

(71) Applicant: Alcoa Inc., Pittsburgh, PA (US)

(72) Inventors: Eric Stull, Lower Burrell, PA (US); James Burg, Verona, PA (US); Todd Cogswell, Lafayette, IN (US); Heather Drieling, Apollo, PA (US); Glenn Jarvis, Allison Park, PA (US); Vivek Sample, Murrysville, PA (US); Jeff Lehner, The Woodlands, TX (US); Narsimhan Raghunathan, Export, PA (US)

(21) Appl. No.: 15/234,533

(22) Filed: Aug. 11, 2016

Related U.S. Application Data
(60) Provisional application No. 62/204,204, filed on Aug. 12, 2015.

(51) Int. Cl. C22F 1/04; B21C 23/08; F16L 9/02; B21B 17/00; B23K 31/02; B22D 11/00

(52) U.S. Cl. CPC C22F 1/04; B23K 31/027; B22D 11/006; B22D 11/003; F16L 9/02; B21B 17/00; B21C 23/085

(57) ABSTRACT

An apparatus, method and composition for long length tubing includes continuous production of long length seamless aluminum tubing suitable for use as coiled tubing in hydrocarbon wells. A 2XXX aluminum alloy may be used in combination with a continuous casting/extrusion apparatus using aluminum from a melt. Other metals may be used, as well as continuously cast rod from a casting wheel and belt or conform extruder, which is processed to form a hollow and then sized by drawing.

### CROSS REFERENCE TO RELATED APPLICATIONS

The present application claims the benefit of U.S. Provisional Application No. 62/204,204, entitled, Apparatus, Manufacture, Composition and Method For Producing Long Length Tubing and Uses Thereof, filed Aug. 12, 2015, which is incorporated herein in its entirety by reference.

### FIELD

The present invention relates to metal tubing and methods and materials for making metal tubing and more particularly, to such materials and methods for making tubing having a long length, such as for use in applications in oil and gas well drilling, hydrocarbon extraction and maintenance.

### BACKGROUND

Various methods and materials for making long lengths of tubing are known, e.g. for use in the oil and gas industry. Oil and Gas Coiled Tubing (CT) has been defined as any tubular product manufactured in lengths that require spooling onto a take-up reel unit during the manufacturing process. The tube is stored on a reel unit prior to use and is then nominally straightened prior to being inserted into the wellbore for operations. When retrieved from the wellbore after use, the tubing is then recoiled back onto the reel unit when not in use. Tubing diameter normally ranges from 0.75 in. to 4 in., and single reel tubing lengths in excess of 30,000 ft. have been commercially manufactured.

Most CT in use today begins as large coils of low-alloy carbon-steel sheet. The starting sheet coils can be up to 55 in. wide and weigh over 24 tons. The length of sheet in each coil depends upon the sheet thickness and ranges from 3,500 ft. for 0.087 in. gauge to 1,000 ft. for 0.250 in. gauge. To get to the long lengths, e.g., 30,000 ft., required for CT applications, the sheet must be spliced together in series at what is called the “bias joint” in the CT industry. Then the sheet is roll formed into a circular tube shape and seam welded using a High Frequency Induction welding process (or an equivalent welding process). Finally, the 30,000 ft. continuous tubing is wrapped onto a large diameter reel unit for pressure testing prior to shipping to the operational site.

Seamless tubing is also known to be produced in accordance with traditional seamless tube manufacturing processes. For example, a billet may be extruded over a mandrel attached to a ram, e.g., as described in U.S. Pat. Nos. 2,819,794, 3,411,337, 3,455,137 and/or 3,826,122 or pierced with a piercing mandrel, as in U.S. Pat. No. 2,159,123. Extrusion or piercing may be followed by a drawing process. Most processes for tube manufacture are limited in their ability to cost effectively produce long lengths, i.e., greater than 1000 ft. of high strength seamless tube due to the combination of billet container limits, slow extrusion rates, press capacity and handling equipment. When long lengths, e.g., greater than 1000 ft., of seamless tubing are desired, e.g., for CT, shorter lengths of tubing are joined using joining technologies, such as welding (fusion, solid state, etc.) or by mechanical coupling. Typically, the joints weaken the resultant CT tube significantly and restrict its utility in many of the more challenging and high value applications. In addition to the degradation in structural performance, many of these joining technologies can also negatively impact the space claim and/or the corrosion performance of the tube, further limiting their applications. Alternative methods, apparatus and materials for making long length tubing therefore remain desirable.

### SUMMARY

The disclosed subject matter relates to a method for making long length tubing, including: providing a source of molten metal; continuously supplying the molten metal to a forming device; forming the molten metal into an elongated tube of a selected length.

In accordance with another embodiment, the process of forming is by continuous extrusion.

In accordance with another embodiment, the process of forming includes forming a solid bar and then forming a hollow tube from the solid bar.

In accordance with another embodiment, the solid bar is formed into the hollow tube by a Mannesmann process.

In accordance with another embodiment, the solid bar is formed into the hollow tube by a conform process.

In accordance with another embodiment, the solid bar has a weakened centralized zone which is subsequently enlarged by drawing through a die with a floating mandrel within the centralized zone.

In accordance with another embodiment, the molten metal is an aluminum alloy.

In accordance with another embodiment, the molten metal is a magnesium alloy.

In accordance with another embodiment, the molten metal is a titanium alloy.

In accordance with another embodiment, the molten metal is a steel alloy.

In accordance with another embodiment, further including the step of altering the dimensions of the tube after the step of formation.

In accordance with another embodiment, the step of altering is conducted by drawing the tube through a die.

In accordance with another embodiment, the step of altering includes positioning a floating mandrel within the tube when the tube is drawn through the die during the step of drawing.

In accordance with another embodiment, further including the step of mechanically processing the tube by at least one of hot rolling, cold rolling or milling.

In accordance with another embodiment, further including the step of thermally processing the tube by at least one of homogenizing, solution heat treating or quenching.

In accordance with another embodiment, further including the step of coiling the tubing into a coil.

In accordance with another embodiment, the step of forming includes forming an elongated sheet then longitudinally rolling the elongated sheet into a tube and welding along a longitudinal seam.

In accordance with another embodiment, further including the step of coiling the elongated sheet into a coil and then subsequently uncoiling the elongated sheet prior to the steps of longitudinally rolling and welding.

In accordance with another embodiment, further including the step of heat treating the elongated sheet prior to the step of rolling.

In accordance with another embodiment, long length tubing has a tube having a length greater than 1000 feet, seamless along its entire length and having a material composition of aluminum alloy.

In accordance with another embodiment, the alloy is in the 2xxx series.

In accordance with another embodiment, the aluminum alloy is selected from one of the AA registered alloys 2001, 2014, 2014A, 2214, 2015, 2015A, 2017, 2017A, 2117, 2219, 2319, 2419, 2519, 2022, 2023, 2024, 2024A, 2124, 2224, 2224A, 2324, 2424, 2524, 2624, 2724, 2824, 2025, 2026, 2027, 2029, 2034, 2039, 2040, 2139, 2050, 2055, 2056, 2060, 2065, 2070, 2076, 2090, 2091, 2094, 2095, 2195, 2295, 2196, 2296, 2097, 2197, 2297, 2397, 2098, 2198, 2099, 2199.

In accordance with another embodiment, the tubing exhibits a cyclic strain hardening response.

### BRIEF DESCRIPTION OF THE DRAWINGS

For a more complete understanding of the present disclosure, reference is made to the following detailed description of exemplary embodiments considered in conjunction with the accompanying drawings.

FIG. 1 is schematic diagram illustrating processing flows in conducting a method for producing elongated tubing in accordance with an embodiment of the present application.

FIGS. 2 and 3 are cross-sectional views of a continuous casting device disclosed in U.S. Pat. No. 6,712,125.

FIGS. 4 and 5 are diagrammatic cross-sectional views of prior art tube drawing apparatus and processes.

FIG. 6 is a cross-sectional view of a tube expansion apparatus and process disclosed in U.S. Pat. No. 8,245,553

FIG. 7 is a diagrammatic depiction of a continuous rod casting apparatus and method like that disclosed in U.S. Pat. No. 2,710,433.

FIGS. 8A-8F are a sequence of processing steps and apparatus disclosed in U.S. Pat. No. 361,954 for forming a hollow member from a solid member.

FIG. 9 is a perspective view of an extrusion apparatus and method disclosed in U.S. Pat. No. 3,765,216.

FIG. 10 is a diagrammatic view of a continuous rod casting apparatus and method disclosed in U.S. Pat. No. 3,623,535.

FIG. 11 is a perspective view of CT being fed into a hydrocarbon well.

FIG. 12 is a graph of cycles to failure vs. pressure for three types of steel tubing and one type of aluminum tubing.

FIGS. 13A and 13B are graphs of stress vs. strain for samples of steel and aluminum alloy tubing, respectively.

### DETAILED DESCRIPTION OF EXEMPLARY EMBODIMENTS

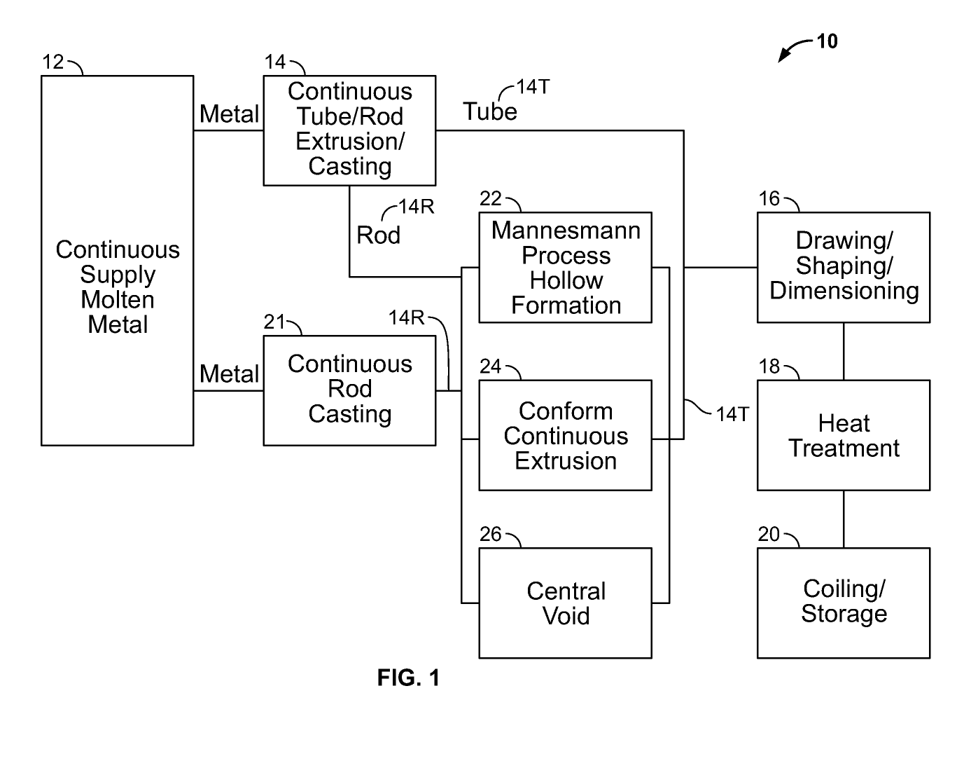

FIG. 1 shows a system 10 that may be employed to produce long lengths, e.g., greater than 1,000 ft., of metal tubing in accordance with an embodiment of the present disclosure. A continuous supply of molten metal 12, such as in a holding furnace/reservoir for molten steel or aluminum alloy, provides molten metal at a rate and volume sufficient to supply the subsequent processing apparatus/steps, 14, 16, etc. on a continual basis. The supply of molten metal 12 may be continuously filled by the output of one or more aluminum smelters or steel furnaces (not shown). The metals used would include high strength steel, aluminum, magnesium, and titanium alloys. The system 10 of FIG. 1 has alternative apparatus and processing pathways for producing tubing. In a first approach, metal obtained from the supply of molten metal 12 is continuously extruded/cast 14 as solid rod or hollow tube by means of a continuous extruding/casting apparatus/process as described in the following U.S. Pat. No. 6,536,508, entitled “Continuous pressure molten metal supply system and method,” U.S. Pat. No. 7,934,627, entitled, “Apparatus and method for high pressure extrusion with molten aluminum,” U.S. Pat. No. 6,915,837, entitled, “Continuous pressure molten metal supply system and method for forming continuous metal articles,” U.S. Pat. No. 6,712,126, entitled, “Continuous pressure molten metal supply system and method,” U.S. Pat. No. 6,712,125 entitled, “Continuous pressure molten metal supply system and method for forming continuous metal articles” and U.S. Pat. No. 6,708,752, entitled, “Injector for molten metal supply system.” Each of the foregoing U.S. Patents are owned by the assignee of the present application, are incorporated by reference herein in their entirety and may be referred to jointly below as the “Alcoa Patents”.

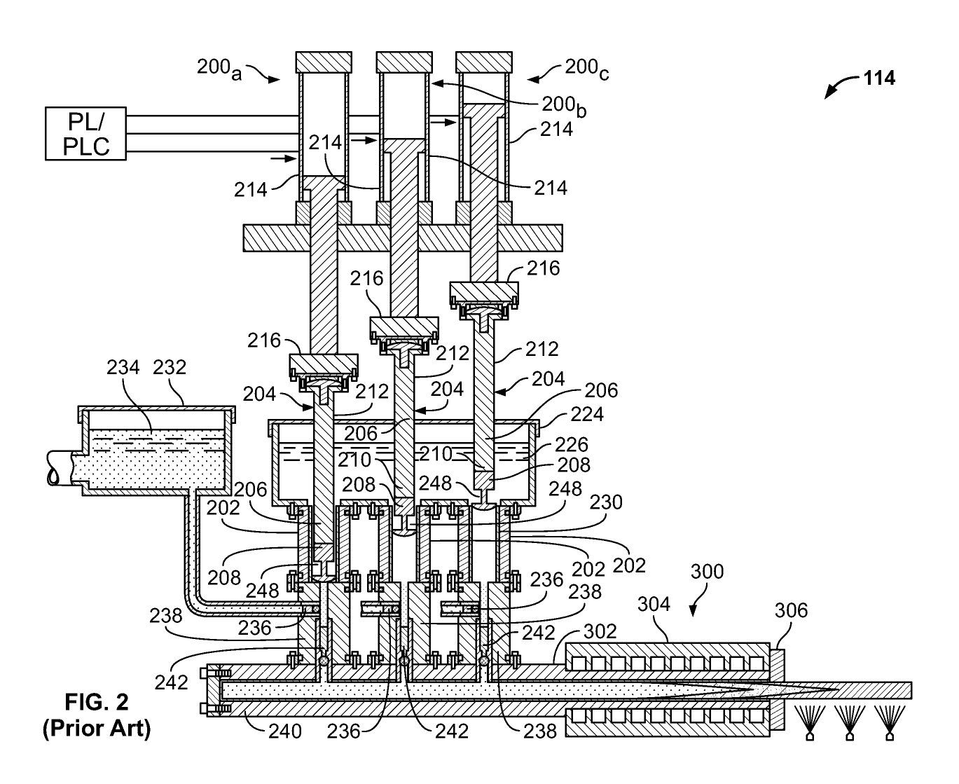

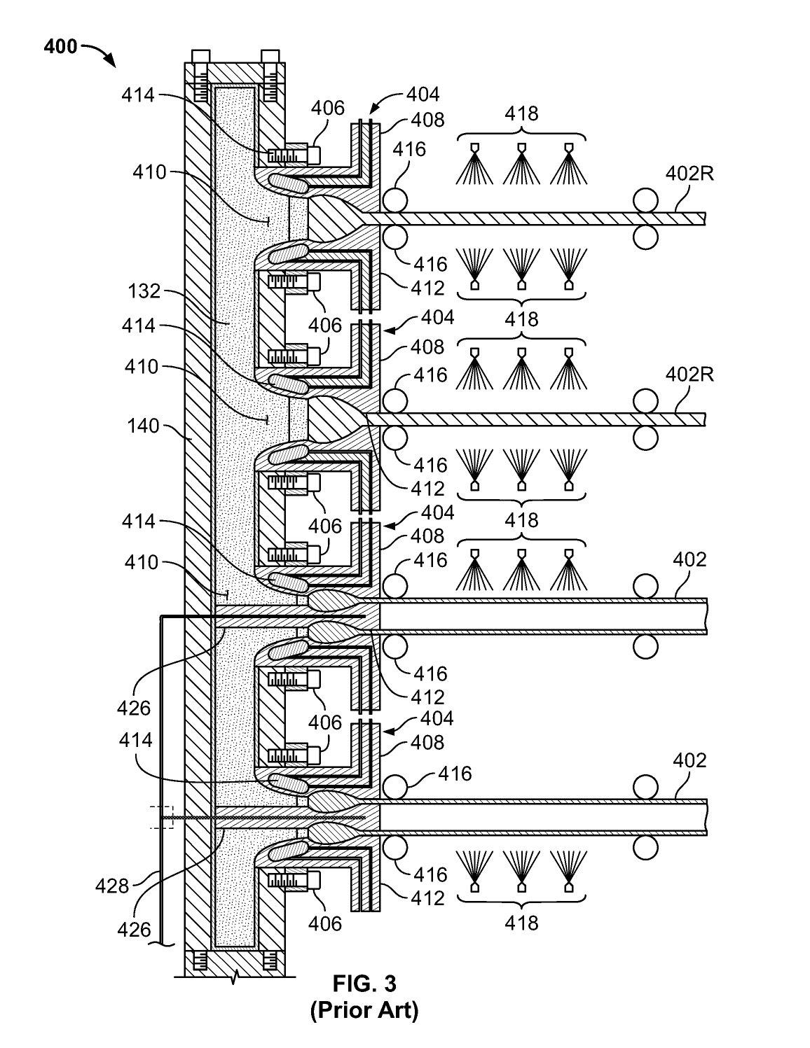

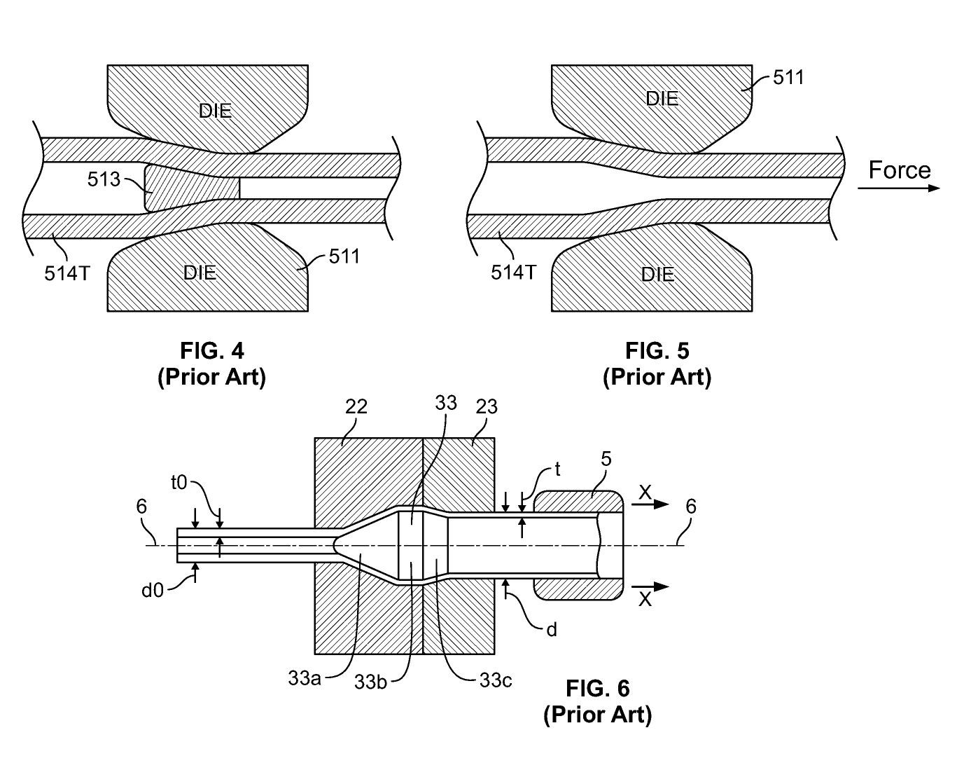

FIGS. 2 and 3 are taken from U.S. Pat. No. 6,712,125 of the Alcoa Patents and illustrate aspects of a continuous casting/extrusion device 114 disclosed therein which pumps metal 234 in reservoir 232 through a die 306 (FIG. 2). Alternatively, the metal may be pumped to a manifold 140 (FIG. 3) with one or more die apertures 412 that form solid rod 402R or hollow tubular extrusions/castings 402T. The apparatus described in the foregoing Alcoa Patents will work with molten aluminum or magnesium alloys. As described in U.S. Pat. No. 6,712,125, for steel, certain parts of the device 114 may be required to be made from higher heat resistant materials to work at the higher temperatures required to keep steel molten, more particularly stable refractory materials such as zirconia may be required. For titanium, even higher temperature capability and less reactive materials for certain parts of the device may be required. Materials, such as tungsten, possibly with a zircon coating, may be required. In the instance where a hollow extrusion (tubing 14T) is produced at apparatus/step 14 of FIG. 1, it may then be drawn and shaped 16, e.g., by passing through one or more drawing dies for conducting a series of drawing processes to produce the quality, strength and dimensional accuracies required. Continuous draw down processes of tubing 514T through a die 511 may be used with floating mandrels 513 as shown in (FIG. 4) and without floating mandrels 513 (FIG. 5). Running a drawing process with and without internal floating mandrels is known in the art. Internal mandrels offer a number of advantages such as concentricity and surface finish improvements. Running without an internal mandrel offers other advantages such as lower operating costs and lower drawing forces. The best process is dependent on many performance and business requirements. It may require internal mandrels, or no internal mandrels, or a combination of both to produce the best product.

Should the extruded (feed) tube 14T (FIG. 1) need to be enlarged e.g., in the case of a rod with a small central void or weakened cored area from a rod caster, as described more fully below, an expanding mandrel, such as an expanding floating mandrel as shown in FIG. 6 and disclosed in U.S. Pat. No. 8,245,553 may be used to expand the tube. While the drawing apparatus and process 16 (FIG. 1) alone may be capable of producing the required geometries and material properties, some in-line, thermal and possibly mechanical processing 18, such as homogenization, solutionizing, quenching, hot rolling, cold rolling, and milling, may be required to produce the best combination of strength, fracture toughness, fatigue resistance and corrosion resistance. The sized, continuous and treated tubing may then be wound on a take-up spool in a coil for storage 20 and transportation.

The coiled tubing may optionally be thermally processed after coiling to obtain desired material properties, e.g., in a batch thermal process 19.

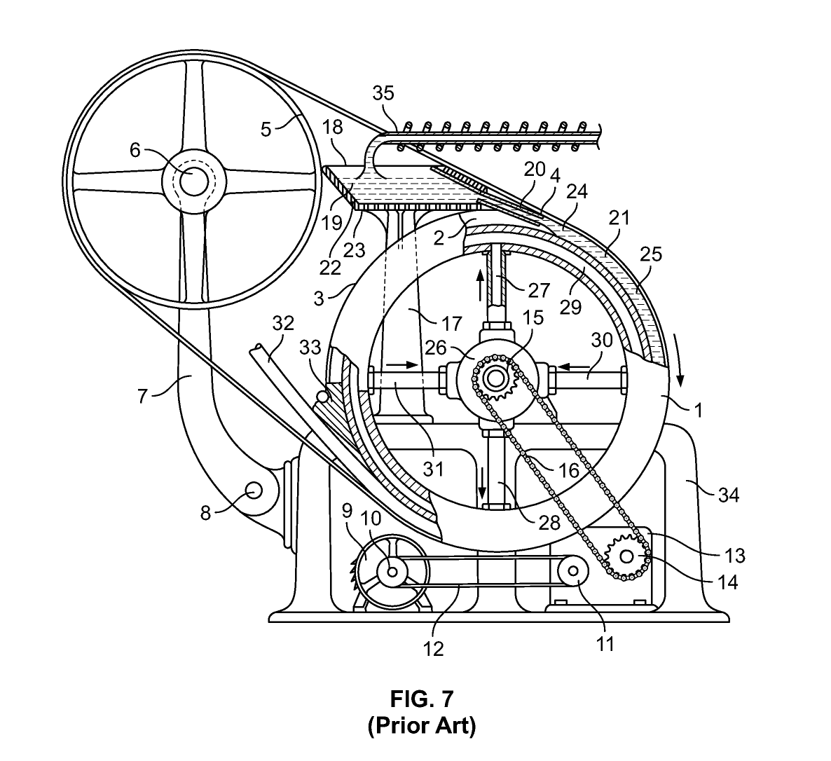

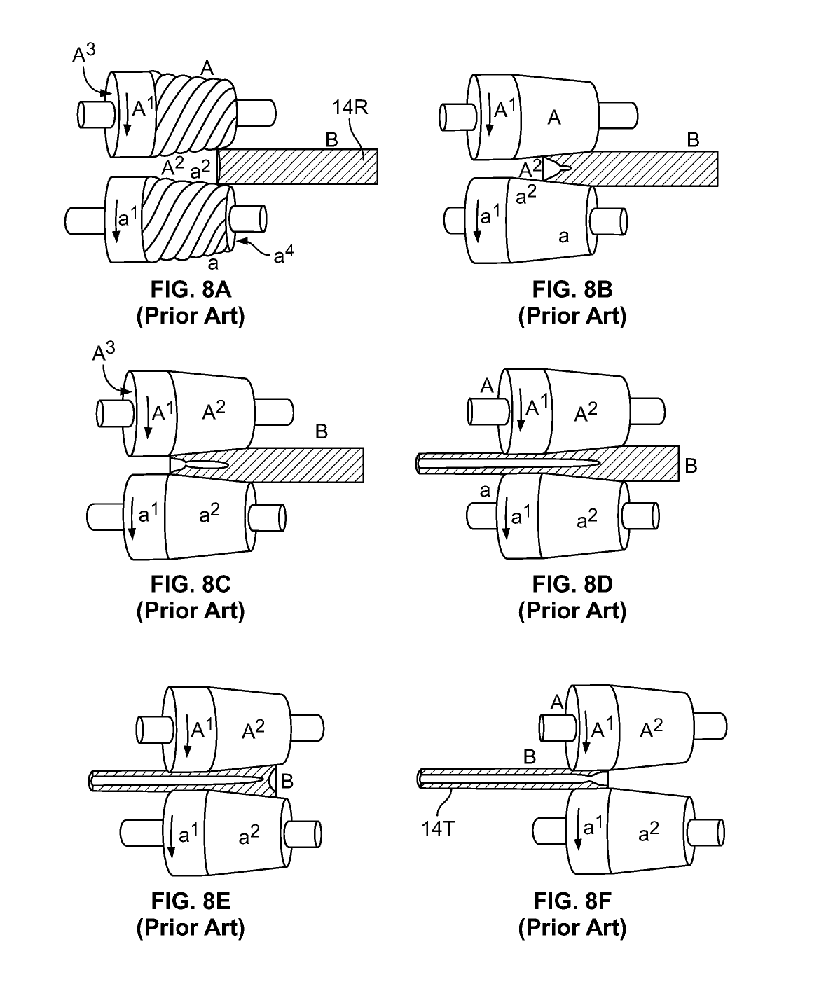

The apparatus and methods disclosed in the Alcoa patents may be used to produce solid extruded or cast rod 14R (FIG. 1), 402R (FIG. 3), instead of tubing, and this rod 14R, 402R may be further processed to form a hollow tube, as described below. Another source of solid rod 14R would be the apparatus and method disclosed in U.S. Pat. No. 2,710,433, U.S. Pat. No. 2,865,067, U.S. Pat. No. 3,623,535, U.S. Pat. No. 378,542, from inventors such as Properzi, Lenaeus, and Hazelett, which are incorporated by reference in its entirety herein and disclose apparatus and methods for continuously casting metal bar or rod by discharge of molten aluminum from a tundish over a casting wheel. FIG. 7 diagrammatically shows a continuous rod caster 610 as described in U.S. Pat. No. 2,710,433 for continuously casting rod 14R. The continuous caster 610 has an upper tundish 612 with a downspout 614 for containing and dispensing molten aluminum metal. Dispensed aluminum is received in lower tundish 616 with a pouring spout 618 that directs the aluminum onto a casting wheel 620. The casting wheel 620 is oiled by a mold oiler 622. The aluminum deposited on the casting wheel is pressed against the surface of the casting wheel 620 and shaped by a continuous belt 624 that is cooled by water boxes 626, solidifying and cooling the molten aluminum deposited on the casting wheel 620. A belt oiler 628 sprays oil on the belt 624. This apparatus and method of producing metal rod, i.e., continuous rod casting 21 (FIG. 1), may also be used in place of the continuous rod extrusion/casting 14 provided by the Alcoa Patents incorporated by reference above. Regardless of the source of the continuous metal rod, (either 14 or 21) the rod 14R must be formed into a tube shape, i.e., provided with an internal hollow in order to produce the continuous tubing product 14T. In one approach, a Mannesmann process, as described in U.S. Pat. No. 361,954 may be used to create the continuous central void in the rod to form a continuous tube. This Mannesmann process is illustrated in FIGS. 8A-8F, wherein a rod 14R is reshaped into a tube 14T. After formation of a tube structure 14T, the tube may then be sized and shaped by the drawing/shaping/dimensioning step 16 described above and in reference to FIGS. 4 and 5 and 6 (if the void needs to be enlarged). The tube structures 14T output from the Mannesmann process 22 may have dimensions that would require only conventional continuous draw down processes, with floating mandrels 513 (FIG. 4) or without floating mandrels (FIG. 5), to produce the required geometries and material property improvements. In-line, or coiled batch, thermo mechanical processing 18 and 19 may be required to produce the best combination of strength, fracture toughness, fatigue resistance and corrosion resistance.

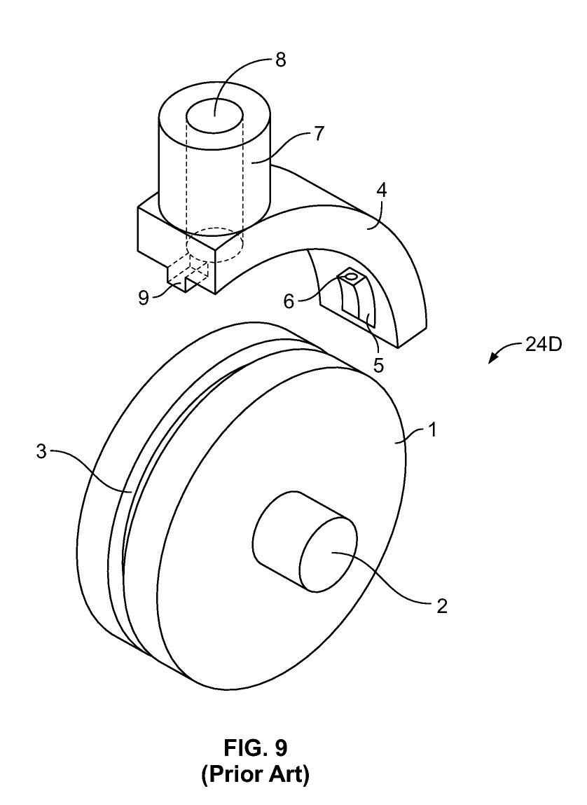

In addition to the Mannesmann process 22 for processing of rod 14R produced by rod extrusion or continuous casting 14, 21, the rod 14R may also be formed into a tube shape by a Conform continuous extrusion process 24 (FIG. 1), as described in U.S. Pat. Nos. 3,765,216, 4,055,979 and 5,167,138 by a device 24D like that illustrated in FIG. 9. In accordance with the present disclosure, a long length seamless tube can be produced using conform continuous extrusion. In one approach, the Conform apparatus 24D and method would receive a continuous feed rod 14R and produce a continuous extruded tube 14T in the final size needed for the application. Alternatively, the Conform process could be used to provide tubes 14T of a size that would require only conventional continuous draw down processes, with floating mandrels 513 (FIG. 4) or without floating mandrels (FIG. 5), to produce the required geometries and cast material property improvements. Again some in-line or coiled batch, thermo mechanical processing may be required to produce the best combination of strength, fracture toughness, fatigue resistance and corrosion resistance.

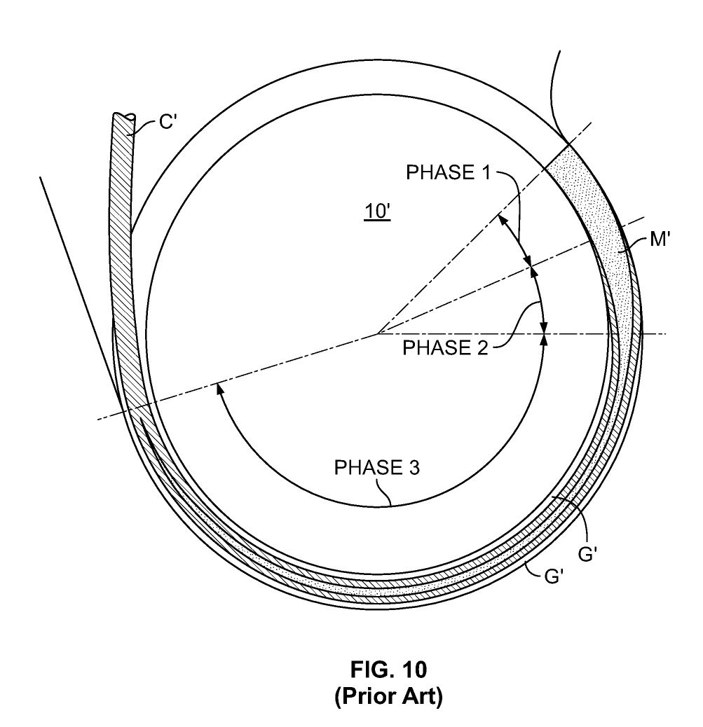

As a further alternative, the first step could be to use a modified rod casting process to supply continuous lengths of rod with central voids or centralized weakened zones. Rods with central voids or centralized weakened zones can be produced on a modified rod caster by accurately controlling the rate of radial heat extraction during solidification, the production rate of the tubes, and the ability to control the feed molten metal to the rod core during solidification. FIG. 10, shows this type of process as disclosed U.S. Pat. No. 3,623,535 and illustrates various phases of solidification during a conventional rod casting process. As show in FIG. 10 and described in U.S. Pat. No. 3,623,535, during the conventional rod casting process, solidification occurs on the outside first and moves inward to the core. By controlling the rate of radial heat extraction, the rate at which the rods are fed through the casters and the height of the molten metal feed container, a centralized void or weakened zone can be created at the center of the rod. These central voids or centralized weakened zones can then be subsequently enlarged using expanding floating mandrels 513 similar to that shown in FIG. 6. The expanding mandrels would develop seamless tubing of the required size, or sizes that would require only conventional continuous draw down processes, with floating mandrels 513 (FIG. 4) or without floating mandrels (FIG. 5) to produce the required geometries and material property improvements. In-line, or coiled batch, thermo mechanical processing may be required to produce the best combination of strength, fracture toughness, fatigue resistance and corrosion resistance. This alternative process will work with all high strength metallic materials (i.e. high strength steel, aluminum, magnesium, and titanium alloys).

### Application

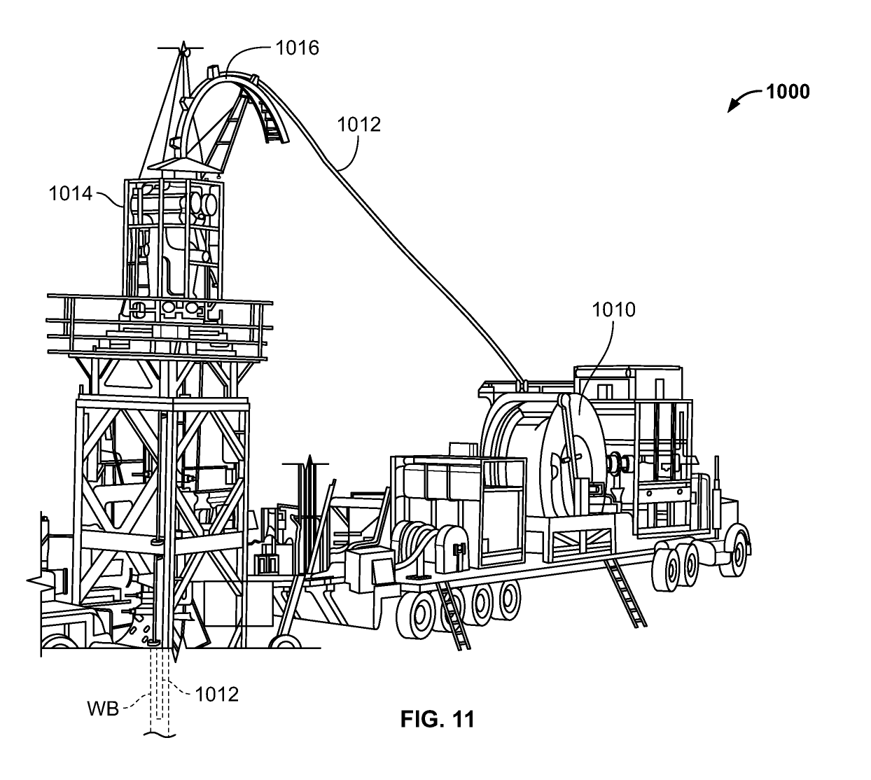

Coiled Tubing (CT) application environments are extremely adverse. They are corrosive, relatively high temperature and structurally challenging environments. FIG. 11 shows apparatus 1000 for transporting a reel 1010 of coiled tubing 1012 to a well and deploying it into the well bore WB. The act of winding the coiled tubing 1012 on the reel 1010 places significant stresses on the tubing 1012, in that the side of the tubing 1012 forming the inner surface of a winding is compressed and the outer surface is stretched (tensioned). Upon unwinding the tubing 1012 from the reel 1010 and straightening it for transmission to the injector 1014, this compression and tensioning is reversed. The tubing 1012 is bent over a guide arch/gooseneck 1016 to change direction to enter the well bore WB, causing a second cycle of bending and straightening. Once in the well, the tubing 1012 is subjected to additional loads, e.g., being suspended for substantial lengths from the injector 1014, bending to conform to the well bore and being subjected to fluids under pressure. The tubing 1012 may also be subjected to mechanical twisting, pushing and pulling during insertion and to perform tasks within the well bore WB, such as during bore cleaning operations. Upon withdrawing the tubing 1012 from the well bore WB, the removal process involves similar bending, stretching and compression, as it is withdrawn and when it is re-wound on the reel 1010. This sequence of events may occur many times over the useful life of the tubing 1012 and the better the tubing 1012 can withstand this type of use before degrading, the longer the useful life. As can be appreciated, any extension in useful life of the tubing 1012 translates into substantial cost savings, since the tubing is expensive to make and transport.

### Alloy

Typically, steel alloys are required to handle the mechanical forces to which CT is subjected. An aspect of the present disclosure is the recognition that while the vast majority of aluminum alloys will not survive in these extremely challenging environments, it is still possible to use an aluminum alloy as disclosed herein as a replacement for steel CT alloys used in the Oil and Gas marketplace. In particular, a 2xxx series heat treatable aluminum alloy, e.g., AA2040 or AA2029 may be used. Furthermore, any 2xxx series heat treatable alloy with a minimum Tensile yield strength of 50 ksi may be useable. This includes but is not limited to AA registered alloys: 2001, 2014, 2014A, 2214, 2015, 2015A, 2017, 2017A, 2117, 2219, 2319, 2419, 2519, 2022, 2023, 2024, 2024A, 2124, 2224, 2224A, 2324, 2424, 2524, 2624, 2724, 2824, 2025, 2026, 2027, 2029, 2034, 2039, 2139, 2040, 2050, 2055, 2056, 2060, 2065, 2070, 2076, 2090, 2091, 2094, 2095, 2195, 2295, 2196, 2296, 2097, 2197, 2297, 2397, 2098, 2198, 2099, 2199.

Aluminum alloys in this composition range demonstrate good properties for CT use. More particularly, they demonstrate a combination of high strength, enhanced toughness, damage tolerance and corrosion resistance, which are especially useful in Oil and Gas CT applications. These alloys also demonstrate good strength and toughness at the elevated temperatures and for the duration of exposure seen in many CT applications. The selected aluminum compositions perform as well or better in uni-axial low cycle (strain controlled and high plastic strain range) fatigue tests than many of the CT steels in use today. Due to the low weight of aluminum compared to steel, CT made from the aluminum alloy disclosed in the present disclosure exhibit significant weight savings for low pressure applications.

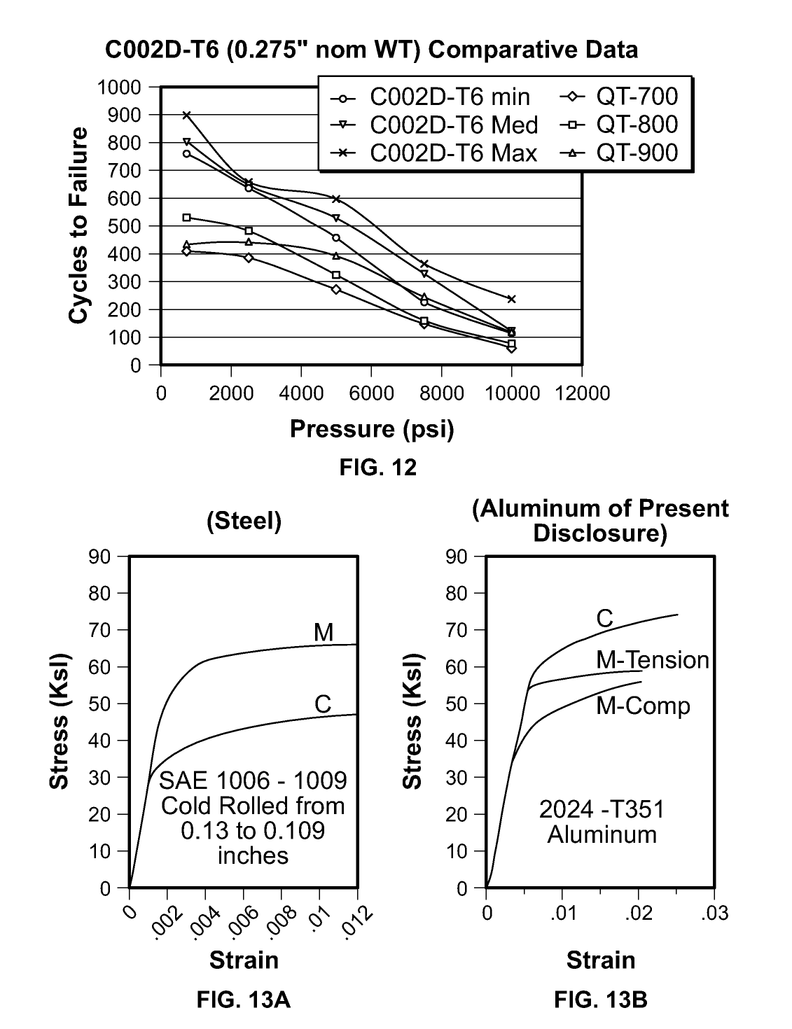

In strain controlled, high plastic strain range fatigue tests, the selected aluminum compositions accumulate plasticity at a slower rate than CT steels. For CT applications, this translates into prolonged life of the aluminum CT at lower internal pressures while simultaneously providing significant weight savings. When extruded into a seamless CT tube, the disclosed aluminum compositions perform as well or better in pressurized bi-axial low cycle (strain controlled and high plastic strain range) fatigue tests than many of the CT steels in use today. These tests are used by the CT industry to gauge the performance of a CT alloy in a particular tube size. This validates in a lab environment the opportunity for significant weight savings when using selected aluminum compositions in this application. An example of these test results are shown in FIG. 12. FIG. 12 shows the low cycle fatigue performance of equivalent cross section tubes tested at varying pressures. The figure shows the performance of one Alcoa aluminum alloy (i.e. C002D) and three conventional steel alloys (i.e. QT-700, QT-800, and QT-900) with static yield stresses varying from 70 ksi (QT-700) to 90 ksi (QT-900). These steel tubes are representative of many of those used in today's coiled tubing applications (as described below). C002D is an alloy similar in composition to AA2040 with a yield strength greater than 50 ksi. Three lines for the aluminum alloy tests are shown. The “Max” data are the tests that did best, the “Med” was the median test results, and the “Min” was the minimum results. The graph shows the aluminum alloy performing better than the steel alloys. This is significant considering the aluminum tube would offer a weight savings of approximately 66%. Steel coiled tubing is currently manufactured and supplied in the United States by three major CT suppliers. This includes Quality Tubing—National Oilwell Varco, Tenaris, and Global Tubing. While the base steel alloys used are similar in composition, naming conventions vary depending on supplier. Quality Tubing products vary from QT-700, QT-800, QT-900, through QT-1300. Global Tubing offer products ranging from GT-80 up to GT-110. Tenaris offers products that range from HS-70 through HS-110. All of these suppliers manufacture their tubing using a roll forming and high frequency seam welding process that is described below.

Another beneficial property of the aluminum compositions of the present disclosure over typical CT steel alloys is their ability to cyclically harden during the low cycle (high plastic strain range) fatigue events that occur during CT operations. Common CT steels cyclically soften under low cycle (high plastic strain range) fatigue events. This strain hardening characteristic enables significant weight savings with the selected aluminum compositions in higher pressure CT applications. Examples of strain controlled cyclic softening of steel and cyclic hardening of aluminum are shown in FIGS. 13A and 13B from an article titled “Fundamentals of Modern Fatigue Analysis for Design”, ASM Handbook on Fatigue and Fracture-Volume 19-Page 235, where M is monotonic and C is cyclic stress. In FIG. 13A a steel sample of SAE 1005-1009 cold rolled from 0.13 to 0.109 inch thickness exhibits a monotonic yield strength of approximately 65 ksi. After cycling the steel specimens in the plastic strain range, the yield stress reduces over a number of cycles and eventually stabilizes at approximately 38 ksi. This material response is described as a strain softening material response. This situation is reversed for the sample of 2024-T351 Aluminum graphed in FIG. 13B. This aluminum alloy exhibits a material cyclic strain hardening response. In this case, the monotonic yield is approximately 45 to 56 ksi depending on whether it is tested in compression or tension, respectively. After cycling the aluminum specimen in the plastic strain range, the yield stress increases over a number of cycles and eventually stabilizes at approximately 63 ksi. Stabilized yield stresses are a key element in the performance of the coiled tube. An aspect of the present disclosure is the recognition that the ability of the aluminum alloys of the present disclosure to strain harden while the steel alloys strain soften is an advantage for aluminum use as applied to CT.

As noted above, using aluminum as the material for CT results in significant reduction in coil reel unit weight over the incumbent steel coil reel unit weight. Reels of coiled tubing are transported from location to location by commercial vehicles on custom CT tractor trailers. These vehicles use the road and bridge systems in the United States and foreign countries where Oil & Gas activities are being performed. The importance of weight savings comes into play due to the overall weight of these vehicles. The average CT vehicle has a gross vehicle weight of approximately 165,000 pounds. Newer, higher capacity vehicles are reaching upwards of 240,000 pounds gross vehicle weight. A reel of steel coiled tubing weighs anywhere between 80,000 to 110,000 pounds. Switching from steel to aluminum can potentially save from 25,000 to 50,000 pounds or more depending on the application and corresponding dimensions of the CT. Reducing the coil reel unit weight significantly reduces the load the truck or trailer must carry. This weight reduction alone is important to the industry. In addition, coil reel weight reductions also enable significant lightening of the vehicles that transport the CT, since their structural load requirements will be significantly reduced. Custom, high capacity CT vehicles require special permits to travel the public roads. These permits are costly and the requirements for permitting are different from state to state, and county to county within a particular state. In addition, there are bridge load rating limits to be considered. If these limits are exceeded, then alternative routes need to be taken, typically representing additional time and cost to the operator. Further, if a CT truck exceeds load limits on certain roads, they may be accessed a fine for noncompliance.

Another significant advantage of aluminum CT in accordance with the present disclosure is the reduction of down hole torque and drag during use. In 10 lb/gal mud, aluminum CT weighs 24% of steel CT of equal size. Reduction in torque and drag can facilitate longer runs in certain well profiles before buckling, lower axial stresses and less stretch and windup. Another benefit of utilizing aluminum over the incumbent steel is better sustainability through recycling. Recycling the aluminum after use is presently provides a recycling value about 8 to 10 times more than steel.

### Use of Aluminum Alloy for Seam Tube Preparation

While a continuous length of aluminum tubing without joints or seams, as described above exhibits beneficial qualities, there may be instances where a seamed aluminum tube is desired, e.g., in those instances where existing steel tube formation equipment is used to make the tubing. Prior art seamed tube preparation is conducted using steel in the following manner. After the diameter of the CT is selected, a steel master coil of proper thickness is slit into strips of a width necessary to form the circumference of the tube. Multiple sections of slit steel are then welded end to end to form a continuous length of steel. The welded steel sections are then rolled onto take-up reels until a sufficient length of steel is accumulated. The sheet steel is then spooled off the coil and run through a series of roller dies that mechanically work the flat steel into the shape of a tube. At a point immediately ahead of the last set of forming rollers, the edges of the tube walls are positioned very close to each other. These edges are then joined together by an electric welding process described as High Frequency Induction (HFI) welding. Additional in-line processing such as weld flash removal, weld seam annealing, thermal processing and eddy-current inspection can also be part of this process, as needed. The last steps in the process are the coiling and pressure testing processes, prior to shipping.

An aspect of the present disclosure is the recognition that a 2XXX alloy, as disclosed above, may be used in forming a traditional tube with a longitudinal seam and intermittent lateral seams to join lengths of tube to form a longer length. A further aspect of the present disclosure is the recognition that a long length metal tube, such as CT, may be formed using a continuous length of flat aluminum alloy stock that is subsequently rolled into a cylinder and joined at a longitudinal seam, but due to the length of the flat stock, lateral joints are not needed. Alternatively, lateral joints may be used to join shorter lengths of aluminum flat stock. In one alternative, the long length of flat aluminum stock is taken up on a storage spool, i.e., coiled, and then subsequently unspooled for rolling and seaming. In another aspect, the long flat aluminum stock is rolled into a cylinder (tube) and longitudinally seamed as it is produced, e.g., by continuous casting. Exemplary continuous sheet or plate casting processes that produce the long flat aluminum stock referred to above are disclosed in U.S. Pat. No. 6,672,368 “Continuous Casting of Aluminum” and U.S. Pat. No. 7,125,612 “Casting of Non-Ferrous Metals,” both of which are owned by the assignee of the present application and are incorporated by reference herein in their entireties. The resultant cylindrical tubing is then coiled on a reel for storage, avoiding the joining of sub-lengths at lateral joints. In yet another aspect of the invention, a continuous length of steel flat stock may be generated using one of the continuous processes described above, e.g., continuous casting, and then rolled into a cylinder (tube) and seamed to generate a desired given length of continuous tubing without lateral seams. Alternatively, the continuous flat steel stock may be coiled prior to uncoiling, rolling and seaming along a longitudinal seam to generate the given length of continuous tubing without lateral seams.

### Exemplary Uses for the Tubing of the Present Disclosure

As the need for deeper and further; exploration, drilling, and extraction is in the future, longer length coiled tubing product will become burdensome due to the extreme weight of the coil and the inability to transport from one location to another in a cost effective, time efficient manner. Coiled tubing produced in accordance with the present disclosure may be used for a variety of applications, including well-intervention and drilling applications related to sand cleanouts or solids-transport efficiency. The process of cleaning sand or solids out of a wellbore requires pumping a fluid down into the well, capturing the solids into the wash fluid, and subsequently carrying the solids to the surface. Coiled tubing can be injected and used as a siphon string to remove scale, produced sand, frac sand and debris. Coiled tubing is used for numerous well intervention activities including; hole cleanout, perforating the wellbore, and also retrieving and replacing damaged equipment. Coiled tubing is used to convey fishing tools and to deliver jarring action in longer horizontal wellbore configurations. Coiled tubing may be used as a conduit that can be pushed into the pipeline with special tooling attached at the end. The conduit allows specialized chemicals to be pumped at pressure to remove scale and wax accumulations in the pipeline. Coiled tubing allows for real-time downhole measurements that can be used in logging operations and wellbore treatments. In some instances, the CT can be used for high pressure pumping to apply high pressure to the potential producing reservoir, causing break-down near the well bore and improving permeability and reservoir properties. CT tubing produced in accordance with the present disclosure may be used for any of the above applications.

The CT of the present disclosure may also be used for velocity strings. More particularly, coiled tubing in accordance with the present disclosure is run into an existing producing well to reduce the effective flow area to allow the natural reservoir pressure to lift water from the reservoir, allowing natural pressure to sustain production in mature producing wells. In yet another use, the CT may be used as an electrical submersible pump (ESP) cable conduit, wherein an ESP cable can be inserted into the coiled tubing prior to installation, enabling the tubing to become a support member for the ESP cable for rapid deployment and retrieval of ESPs. The CT may also be used in drilling. More particularly, improvements have been made in recent years using downhole motors for drilling. Advancements have enabled new techniques for lateral wellbore drilling from a “mother bore”. Some new coiled tubing drilling rigs have the capability to drill and case well with dramatic improvements in time savings. Indications are that advancements with heavy duty coiled tubing drilling technology are leading to larger 3½″ and 4½″ tubing for drilling requirements. The manufacturing processes and alloys disclosed herein are not limited in diameter or wall thickness. Therefore, as the diameters continue to grow, aluminum can continue to offer significant weight savings with no loss in performance. The CT of the present disclosure may also be used for the purpose of pipeline cleanout, wherein coiled tubing is used as a conduit that can be pushed into the pipeline with special tooling attached at the end. The CT allows specialized chemicals to be pumped at pressure to remove scale and wax accumulations in the pipeline.

It will be understood that the embodiments described herein are merely exemplary and that a person skilled in the art may make many variations and modifications without departing from the spirit and scope of the claimed subject matter. All such variations and modifications are intended to be included within the scope of the present disclosure.

We claim:

1. A method for making long length tubing, comprising:
providing a source of molten metal;
continuously supplying the molten metal to a forming device;
forming the molten metal into an elongated tube of a selected length.

2. The method of claim 1, wherein the process of forming is by continuous extrusion.

3. The method of claim 1, wherein the process of forming includes forming a solid bar and then forming a hollow tube from the solid bar.

4. The method of claim 3, wherein the solid bar is formed into the hollow tube by a Mannesmann process.

5. The method of claim 3, wherein the solid bar is formed into the hollow tube by a Conform process.

6. The method of claim 3, wherein the solid bar has a weakened centralized zone which is subsequently enlarged by drawing through a die with a floating mandrel within the centralized zone.

7. The method of claim 1, wherein the molten metal is an aluminum alloy.

8. The method of claim 1, wherein the molten metal is a magnesium alloy.

9. The method of claim 1, wherein the molten metal is a titanium alloy.

10. The method of claim 1, wherein the molten metal is a steel alloy.

11. The method of claim 1, further comprising the step of altering the dimensions of the tube after the step of formation.

12. The method of claim 11, wherein the step of altering is conducted by drawing the tube through a die.

13. The method of claim 12, wherein the step of altering includes positioning a floating mandrel within the tube when the tube is drawn through the die during the step of drawing.

14. The method of claim 1, further comprising the step of mechanically processing the tube by at least one of hot rolling, cold rolling or milling.

16. The method of claim 1, further comprising the step of thermally processing the tube by at least one of homogenizing, solution heat treating or quenching.

17. The method of claim 1, further comprising the step of coiling the tubing into a coil.

18. The method of claim 1, wherein the step of forming includes forming an elongated sheet then longitudinally rolling the elongated sheet into a tube and welding along a longitudinal seam.

19. The method of claim 18, further comprising the step of coiling the elongated sheet into a coil and then subsequently uncoiling the elongated sheet prior to the steps of longitudinally rolling and welding.

20. The method of claim 18, further comprising the step of heat treating the elongated sheet prior to the step of rolling.

21. Long length tubing, comprising:
a tube having a length greater than 1000 feet, seamless along its entire length and having a material composition of aluminum alloy

22. The tubing of claim 21 wherein the alloy is in the 2xxx series.

23. The tubing of claim 21, wherein the aluminum alloy is selected from one of the AA registered alloys 2001, 2014, 2014A, 2214, 2015, 2015A, 2017, 2017A, 2117, 2219, 2319, 2419, 2519, 2022, 2023, 2024, 2024A, 2124, 2224, 2224A, 2324, 2424, 2524, 2624, 2724, 2824, 2025, 2026, 2027, 2029, 2034, 2039, 2139, 2040, 2050, 2055, 2056, 2060, 2065, 2070, 2076, 2090, 2091, 2094, 2095, 2195, 2295, 2196, 2296, 2097, 2197, 2297, 2397, 2098, 2198, 2099, 2199.

24. The tubing of claim 21, wherein the tubing exhibits a cyclic strain hardening response.
